(19) United States
(12) Patent Application Publication
(10) Pub. No.: US 2010/0318913 A1
(43) Pub. Date: Dec. 16, 2010

(54) METHOD AND APPARATUS OF PROVIDING GRAPHICAL USER INTERFACE FOR VISUALLY STREAMING MEDIA

(76) Inventors: Shiraz Cupala, Seattle, WA (US); David Fleischman, Issaquah, WA (US); Randy Kerr, Edmonds, WA (US)

Correspondence Address: DITTHAVONG MORI & STEINER, P.C., 918 Prince Street, Alexandria, VA, 22314, US

(21) Appl. No.: 12/484,953

(22) Filed: Jun. 15, 2009

(51) Int. Cl. G06F 3/01; G06F 3/048

(52) U.S. Cl. 715/719; 715/838; 715/716

(57) ABSTRACT

An approach is provided for determining that a plurality of media feeds from one or more media sources are to be presented, and initiating presentation of a graphical user interface in which the plurality of media feeds are displayed. The media feeds are displayed as a respective plurality of images representative of content of the respective media feed. The plurality of images are displayed in motion, and move differently from one another.

### BACKGROUND

Wireless (e.g., cellular) service providers and device manufacturers are continually challenged to deliver value and convenience to consumers by, for example, providing compelling network services, applications, and content, as well as user-friendly devices. An important differentiator in this industry is the user interface. In particular, user interfaces for online communities can be determinative of the success of failure of such network services.

### SOME EXAMPLE EMBODIMENTS

According to one embodiment, a method comprises determining that a plurality of media feeds from one or more media sources are to be presented, and initiating presentation of a graphical user interface in which the plurality of media feeds are displayed as a respective plurality of images representative of content of the respective media feed, wherein the plurality of images are displayed in motion, and move differently from one another.

According to another embodiment, an apparatus comprising at least one processor, and at least one memory including computer program code, the at least one memory and the computer program code configured to, with the at least one processor, cause the apparatus to perform at least the following, determine that a plurality of media feeds from one or more media sources is to be presented, and initiate presentation of a graphical user interface in which the plurality of media feeds are displayed as a respective plurality of images representative of content of the respective media feed, wherein the plurality of images are displayed in motion, and move differently from one another.

According to another embodiment, an apparatus comprising means for determining that a plurality of media feeds from one or more media sources are to be presented, and means for initiating presentation of a graphical user interface in which the plurality of media feeds are displayed as a respective plurality of images representative of content of the respective media feed, wherein the plurality of images are displayed in motion, and move differently from one another.

According to yet another embodiment, a computer-readable storage medium carrying one or more sequences of one or more instructions which, when executed by one or more processors, cause an apparatus to perform at least the following: present a graphical user interface that includes, a plurality of images corresponding respectively to a plurality of media feeds from one or more media sources, wherein the plurality of images are presented in motion, and move differently from one another.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of providing a graphical user interface for one or more media feeds for users of a media sharing community, according to an exemplary embodiment;

FIG. 2 is a diagram of components of a graphical user interface architecture, according to an exemplary embodiment;

FIG. 3 is an interaction map of various graphical user interfaces, according to one embodiment;

FIG. 4A is a display including a graphical user interface for a plurality of media feeds, according to one embodiment;

FIG. 4B is a graphical user interface for one or more media feeds, according to one embodiment;

FIG. 4C is a display including a graphical user interface for a plurality of media feeds including metadata information, according to one embodiment;

FIG. 4D is a display including an embedded view of a graphical user interface for a plurality of media feeds, according to one embodiment;

FIG. 5A is a display including a graphical user interface for a plurality of media feeds including a persistent control bar, according to one embodiment;

FIG. 5B is a display including a graphical user interface for a plurality of media feeds including rollover control bars, according to one embodiment;

FIG. 5C is a display including a graphical user interface for a plurality of media feeds where a media feed is selected and including metadata information shown in a side bar, according to one embodiment;

FIG. 5D is a display including a graphical user interface for a plurality of media feeds where a media feed is selected and including metadata information shown in overlays, according to one embodiment;

FIG. 5E is a display including a graphical user interface for a plurality of media feeds where a media feed is zoomed and including a control bar outline, according to one embodiment;

FIG. 5F is a display including a graphical user interface for a plurality of media feeds where a video media feed is selected and including metadata information shown in a side bar and including a video control bar overlay, according to one embodiment;

FIG. 6A is a method of providing a graphical user interface for media feeds including representative images of the media feeds displayed in motion, according to one embodiment;

FIG. 6B is a method of prioritizing media sources of media feeds and assigning movement rates to the priorities for use in a graphical user interface for the media feeds, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile station (e.g., handset) that can be used to implement an embodiment of the invention.

### DESCRIPTION OF SOME EMBODIMENTS

A method and apparatus for providing a graphical user interface for streaming media are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

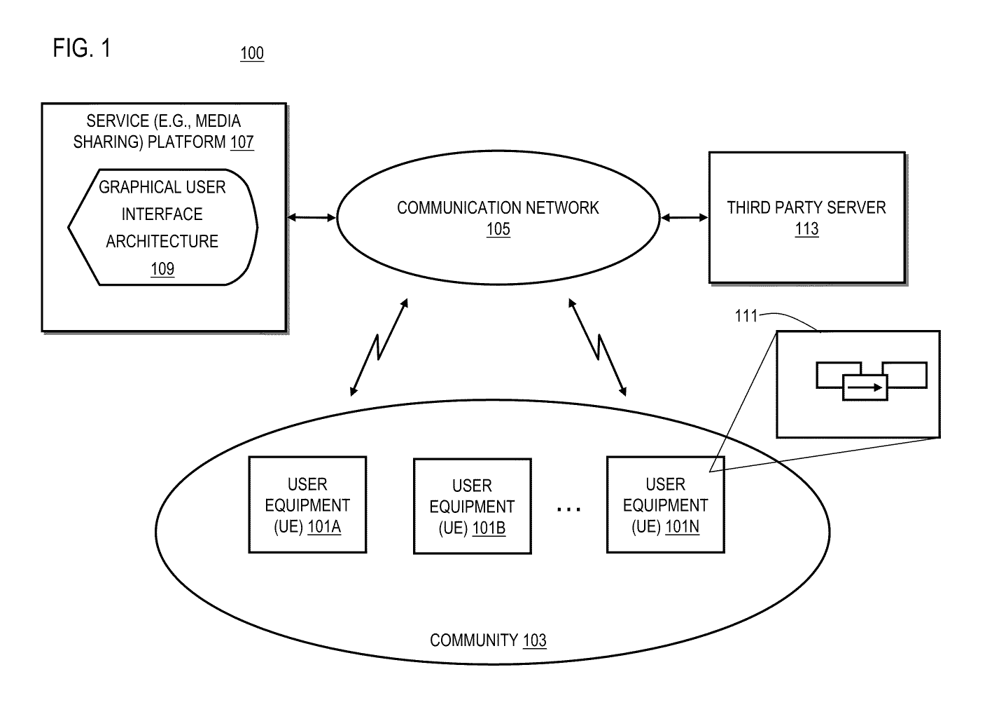

FIG. 1 is a diagram of a communication system 100 capable of providing a graphical user interface for one or more media feeds for users of a media sharing community, according to an exemplary embodiment. As shown in FIG. 1, the system 100 comprises one or more or user equipment (UEs), e.g., UEs 101A, 101B, . . . 101N, which can be utilized by various users (e.g., registered users or temporary visitor's) of a media sharing community 103. The UEs 101A-101N can utilize a communication network 105 to connect to a service application or platform 107 that includes graphical user interface architecture 109. For the purposes of illustration, the service platform 107 is described with respect to media sharing; however, it is contemplated that other services, e.g., social networking, can be provided. The UEs 101A-101N are any type of mobile terminal, fixed terminal, or portable terminal including mobile handsets, mobile phones, mobile communication devices, stations, units, devices, multimedia tablets, digital book readers, game devices, audio/video players, digital cameras/camcorders, positioning device, televisions, radio broadcasting receivers, Internet nodes, communicators, desktop computers, laptop computers, Personal Digital Assistants (PDAs), or any combination thereof. For example, the UE 101A can employs a radio link to access network 105, while connectivity of UE 101N to the network 105 can be provided over a wired link. It is also contemplated that the UEs 101A-101N can support any type of interface to the user (such as “wearable” circuitry, etc.). In exemplary embodiments, the UEs 101A-101N each includes a media application 111 for providing a media sharing graphical user interface for use in a service (e.g., media sharing) community 103 that allows the various UEs 101A-101N to share and view media. The UEs 101A-101N may share various forms of media with other users via the communication network 105 using the media sharing platform 107 or a third party server 113 with connectivity over the communication network 105. In addition to registered users, visitors (unregistered users) can use user equipment (UEs) to access the media sharing community on a limited and/or temporary basis.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

By way of example, the UEs 101A-101N communicate with the media sharing platform 107 and other members of the community 103 over the communication network 105 using standard protocols. The UEs 101A-101N and the media sharing platform 107 are network nodes with respect to the communication network 105. In this context, a protocol includes a set of rules defining how the network nodes within the communication network 105 interact with each other based on information sent over the communication links. For instance, members of the community 103 may communicate using a social networking protocol. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

The system 100 relates to services, such as web services, and is configured to provide a dynamic graphical user interface to users of a media sharing/publishing site. Media sharing sites would like to offer such dynamic graphical user interfaces for all the site users. Currently, media sharing sites, such as Flickr® or YouTube®, provide static views to users, which do not present the media in an exciting manner for the users.

The system 100 can be used to allow a media sharing site, for example one connected to users' mobile devices, such as Ovi Share®, Nokia Image Exchange, etc., to provide a GUI that includes media feeds with representative images that are in motion in an aesthetically pleasing manner on the GUI. In such a system, the users can embed media into a website of the user that is accessible by other users, either publically or on a restricted basis, and the embedded media feeds can be displayed in a GUI that shows the various media feeds as representative images that are in motion, and can be moving in a different manner from one another. For example, the representative images can be moving in different patterns, at different speeds, at different depths, and/or shown in different sizes (either static sizes, or in changing sizes) from one another. The media feeds can be grouped together based on metadata and/or the movements of the media feeds or groups of media feeds can be dependent upon the metadata. For example, certain priority rankings can be assigned to certain metadata information, and such ranked priorities can be assigned a particular movement (e.g., lower priority moves at a fast rate and higher priority moves at a slower rate; lower priority are shown in smaller sizes and higher priority are shown in larger sizes; lower priority move across the background of the GUI and higher priority moves across the foreground of the GUI, etc.) The various priorities, rankings, and/or movement settings can be adjusted by the user and/or by the source of the media and/or by the service provider. Thus, the users are provided with a dynamic GUI that is very engaging to the users. For example, embodiments of the GUI could be likened to the movement of fish within a fish bowl or fishtank, which can present the media feeds to the user (i.e., observer) in a dynamic and engaging manner.

By way of example, the system can be implemented as a web site in the media sharing site at hand, or also as a software application, desktop software application, slide show, mobile device home screen/active idle widget, Nokia® Web Runtime application, Facebook® application, etc. so that visitors that utilize the system are not forced to use the service web site.

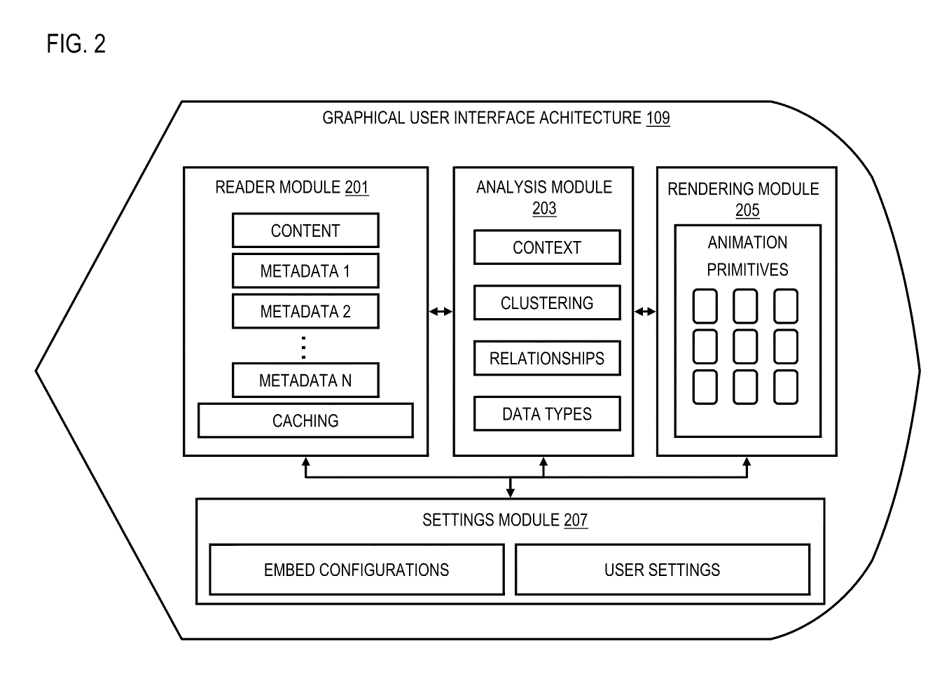

FIG. 2 is a diagram of components of a graphical user interface architecture 109, according to an exemplary embodiment. The media sharing platform includes a reader module 201, which can, e.g., employ RSS (Really Simple Syndication), an analysis module 203, a rendering module 205, and a setting module 207, which can each interact with one another to provide the GUI. Although, the reader module 201 is explained with respect to RSS, it is contemplated that any type of media feed technology can be utilized; for example, even a proprietary feed or other standard feed format can be implemented.

The Reader module 201 can support a wide variety of media file types, include various picture formats, video formats, audio formats, multimedia formats, etc. The Reader module 201 can receive media feeds from various media sources, parse the content of the media feed, as well as the metadata information (metadata 1, metadata 2, . . . , metadata N, such as keywords, title, description, location data, various tags, dates, comments, etc., that are captured automatically or entered by users) provided with the media feed and store the contents and metadata in a cache. The analysis module 203 can determine the context of the content and/or metadata for each media feed, determine clustering or grouping of such media feeds based on the context and based on relationships and/or data types of the metadata, and based on various clustering settings from the user settings stored in the settings module 207. The analysis module 203 can prioritize the media feeds or groupings of media feeds and clustering using priority algorithms and can assign certain priority rankings to certain metadata information, and such ranked priorities can be assigned a particular movement (e.g., lower priority moves at a fast rate and higher priority moves at a slower rate; lower priority are shown in smaller sizes and higher priority are shown in larger sizes; lower priority move across the background of the GUI and higher priority moves across the foreground of the GUI, etc.).

Based on the results of the analysis performed by the analysis module (i.e., resulting clusterings/groups, priorities, rankings, assigned movements, etc.), the rendering module 205 can generate the necessary animation for each media feed. For example, the rendering module 205 can determine a representative image for the GUI, whether a still frame, video clip (all or a portion of the video feed), audio image (e.g., musical note symbol, image of artist, etc.), etc., with or without metadata, for each media feed. The rendering module 205 can also determine the characteristics or manner in which the representative image is displayed on the GUI, for example, the size (static or changing), shape, speed of movement, pattern of movement (direction, course, etc.), depth of field on the GUI at which it is shown, etc. The rendering module 205 can utilize animation primitives with predefined media displays for such characteristics. The settings module 207, according to certain embodiments, stores user preferences or embedding configurations, which can be set on the service provider side, as well as user settings for the GUI that can be accessed by the rendering module 205 during generation of the GUI.

The above arrangement, in certain embodiments, advantageously permits efficient management of content, thereby effectively reducing processing power associated with the user having to navigate through many unwanted applications to select content. Also, power savings are achieved in that users can minimize inefficient navigation and launching of applications to seek for content.

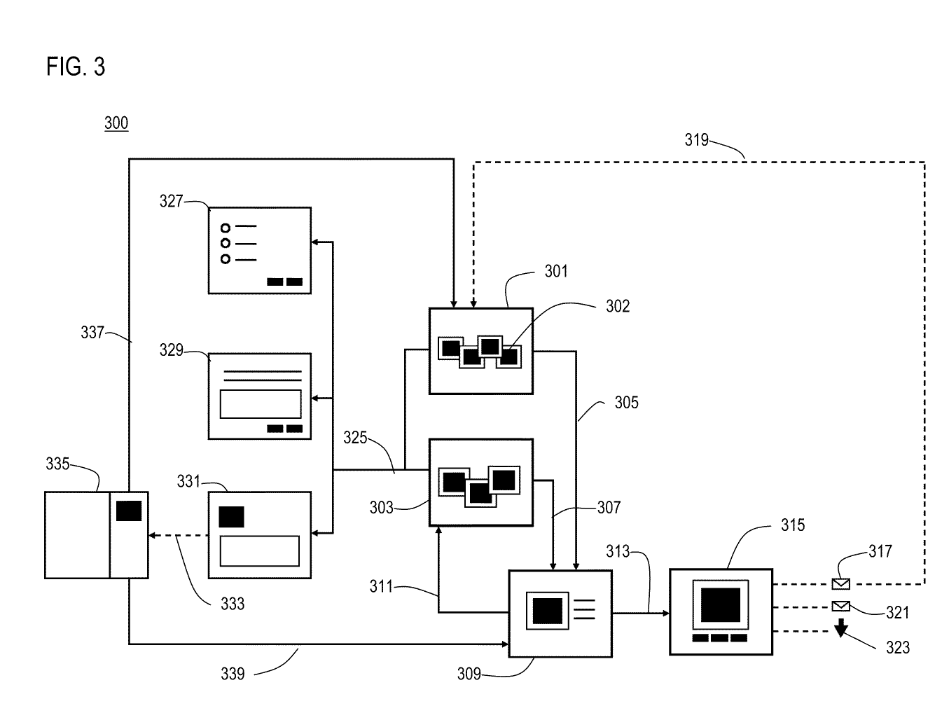

FIG. 3 is an interaction map 300 of various graphical user interfaces, according to one embodiment. In GUI 301, various representative images 302 of the media feeds are depicted. Such representative images 302 are in motion (e.g., moving to the left, right, upward, and/or downward, etc., in different patterns, etc.). In GUI 301, all of the media feeds are represented by representative images on the GUI. GUI 303 is a sorted media feed view that can be selected by the user, which includes a grouping/clustering of media feeds, and can include a textual representation (not shown) of the particular grouping/clustering shown (e.g., date taken (e.g., “Jan. 1, 2009”), location taken (e.g., “Maui”), user defined category, etc.). If the user selects a particular representative image from either the entire media feed GUI view 301 or the sorted media feed GUI view 303 (as represented by arrows 305 and 307), then a media focus GUI view 309 is presented in which the selected representative image is enlarged and certain metadata displayed next to the image. The user can then select a particular metadata grouping and the view will return to a sorted media feed GUI view 303, as represented by arrow 311, based on the particular metadata grouping selected by the user. The user can alternatively zoom in on the representative image, as represented by arrow 313, which will display a zoomed media feed GUI view 315 having various controls (e.g., to access settings, add comments, control the payback of video or audio, etc.). From the zoomed media feed GUI view 315, the user can send the media or a link to the media via email 317, which can then return the user to GUI 301 (as represented by arrow 319), to GUI 303, back to GUI 315, etc. Alternatively, the user can send the media or a link to the media via SMS (short message service) 321, or can download the media to the user's device 323.

In this example, from either the entire media feed GUI view 301 or the sorted media feed GUI view 303, a settings GUI view 327, a comments GUI view 329, or an embed GUI view 331 can be accessed, as represented by three-pronged arrow 325. In the settings GUI view 327, the user can select various display settings for the GUI. In the comments GUI view 329, the user can add comments to the GUI, to particular media feeds, or to particular representative images. In the embed GUI view 331, the user can embed the entire media feed GUI view 301 or the sorted media feed GUI view 303 in an external site 335, as represented by arrow 333. By selecting the embedded view from the external site 335, the user can access the entire media feed GUI view 301, as represented by arrow 337, or the sorted media feed GUI view 303, or the media focus GUI view 309, as represented by arrow 339. The above arrangement permits viewing of more detail about an item, manipulating that item, and/or augmenting the time in the context of the GUI “fishbowl” display.

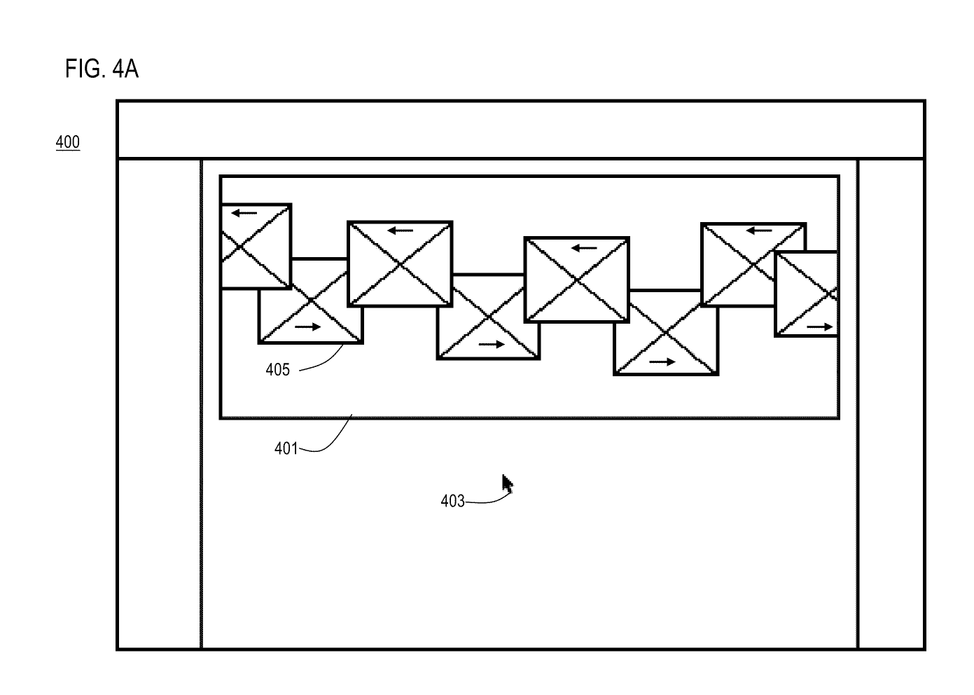

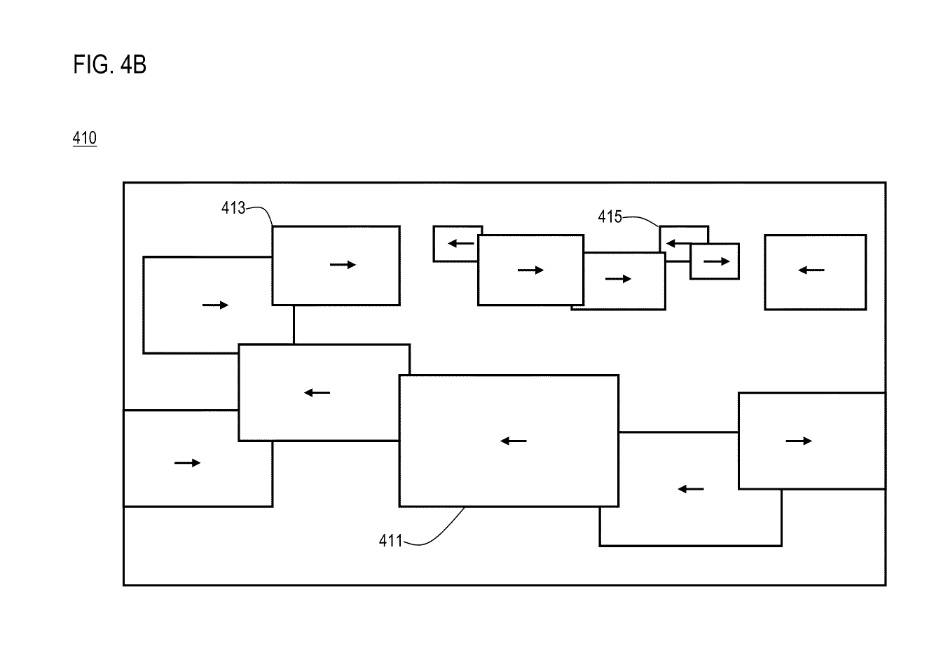

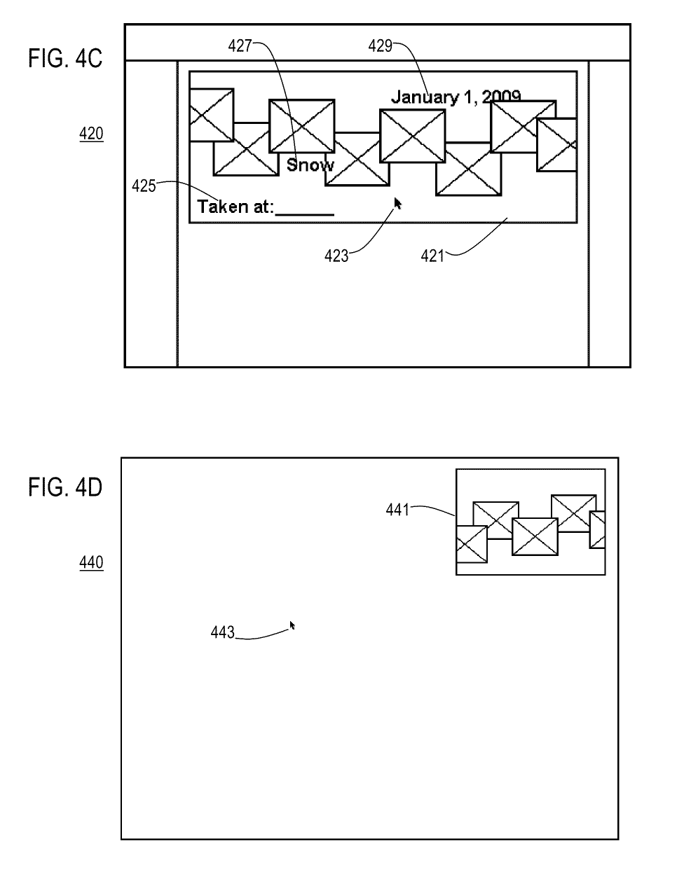

FIG. 4A is a display 400 including a graphical user interface 401 for a plurality of media feeds, according to one embodiment. The display 400 includes a panel or window for the GUI 401, and a selection tool or arrow 403 is provided on the display 400. Within the GUI 401, a plurality of representative images 405 are displayed. In this depiction, the representative images are shown generically here with an “X” through them (for the sake of simplicity) and with a direction arrow indicating a current movement direction across the GUI. In this particular embodiment, the GUI 401 currently depicts four lower representative images that are moving in a left-to-right direction and four upper representative images that are moving in a right-to-left direction. Additionally, three of the lower representative images are shown in the background as compared to the upper representative images, and one of the lower representative images is shown in the foreground of one of the upper representative images, thus giving depth to the GUI. While this embodiment shows the images moving generally in two rows and in left/right directions, the images can move in any variety of patterns, in any direction, at any speed, and need not move in rows. Additionally, while this embodiment shows the images having the same or substantially the same size and shape, the images can be presented in any variety of shapes and sizes that are either static or changing.

FIG. 4B is a graphical user interface 410 for one or more of media feeds, according to one embodiment. In this embodiment, the representative images are shown in various sizes, and travelling in various directions, and at various depths (i.e., foreground/background relationships). For example, a first representative image 411 is shown in the foreground in a large representation, while a second representative image 413 is shown smaller than image 411, and a third representative image is shown in the background and smaller than image 413.

FIG. 4C is a display 420 including a graphical user interface 421 for a plurality of media feeds including metadata information, according to one embodiment. In FIG. 4C, the selection arrow 423 is within the GUI 421, and can be used to select a representative image to view additional information regarding the image or to zoom in on the image, etc. The GUI 421 shown in FIG. 4C includes the display of various metadata related to the representative images in the GUI 421. The display of such metadata can be controlled using user settings. In this embodiment, a first metadata representation 425 is shown that indicates a location at which the media feeds were taken. Also, a second metadata representation 427 is shown as “Snow,” which reflects a descriptive term, keyword, or title given to the media feeds by, for example, the user. Further, a third metadata representation 429 is shown as “Jan. 1, 2009,” reflects the date the media feeds were taken on. The metadata representations can be display in the foreground and/or the background of the image representations. Also, the metadata representations can be stationary and/or in motion (e.g., in the same or various speeds, patterns, etc.), and shown in the same or various colors.

FIG. 4D is a display 440 including an embedded view 441 of a graphical user interface for one or more media feeds, according to one embodiment. In such an embedded view 441, the GUI can be displayed in a reduced size, for example, in a side or corner of the display 440 with the image representation and/or metadata representations in motion. The user can use the selection arrow 443 to select the embedded view, which will enlarge the view to a normal size, in the manner discussed with respect to external site 335 in FIG. 3.

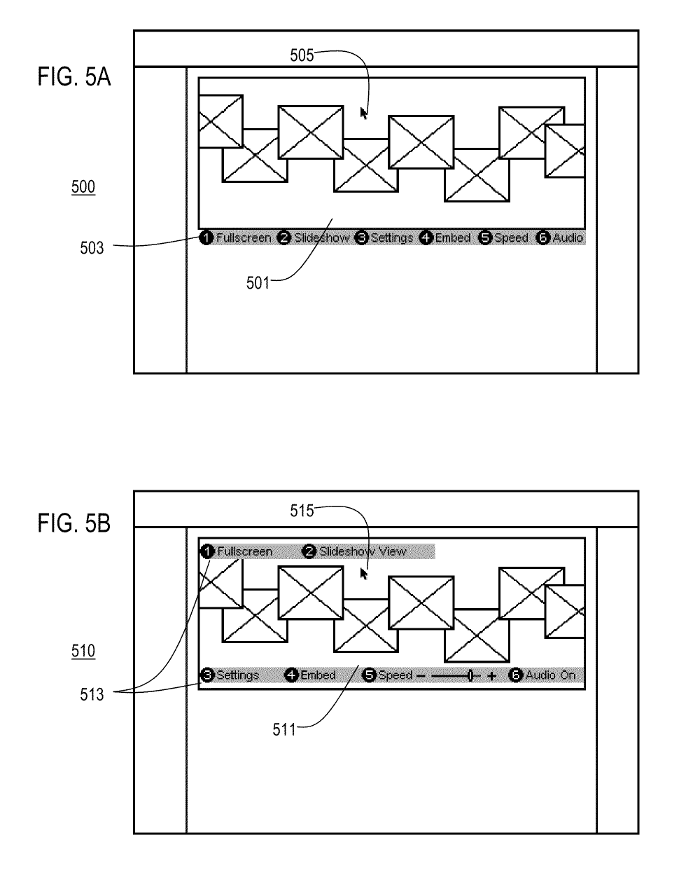

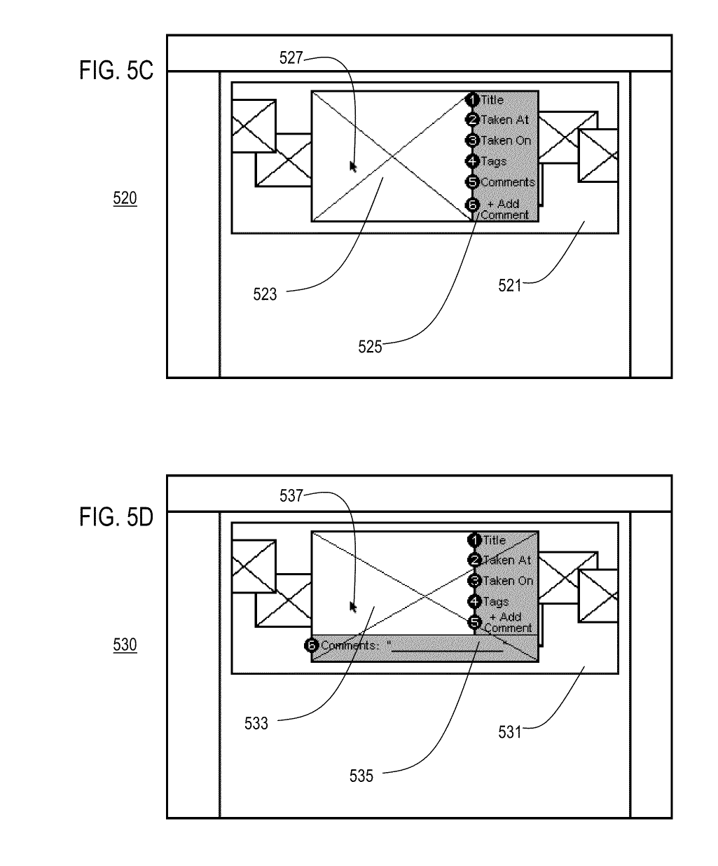

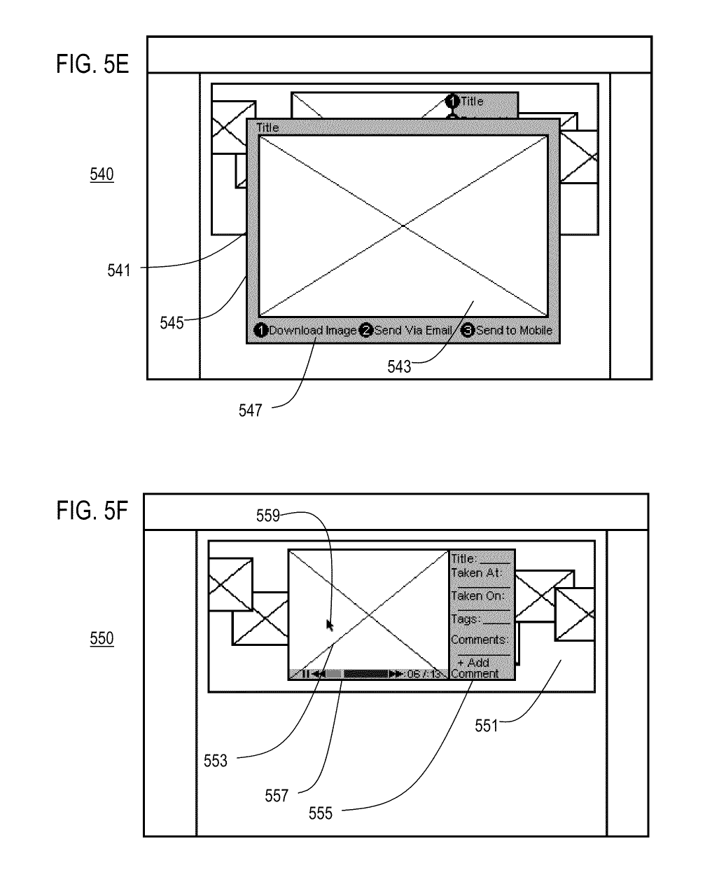

FIG. 5A is a display 500 including a graphical user interface 501 for a plurality of media feeds including a persistent control bar 503, according to one embodiment. In this embodiment, which relates, for example, to GUI views 301 or 303 in FIG. 3, a control bar 503 is provided directly beneath the GUI 501. In this embodiment, the control bar 503 is displayed at all times when the GUI 501 is displayed. The user can use selection arrow 505 to select one of the controls, such as a fullscreen control that enlarges the GUI 501, a slideshow control that switches the GUI to a slideshow format, a settings control that switches to a setting GUI such as view 327 in FIG. 3, an embed control that switches to an embed GUI such as view 331 in FIG. 3, a speed control that allows the user to control overall speed settings for the representative images, and an audio control that toggles between on and off and/or controls the level of sound output.

FIG. 5B is a display 510 including a graphical user interface 511 for a plurality of media feeds including rollover control bars 513, according to one embodiment. In this embodiment, which relates, for example, to GUI views 301 or 303 in FIG. 3, one or more control bars 513 are provided in an overlaid manner within the GUI 511. In this embodiment, the control bars 513 are displayed at all times when the selection arrow 515 is within the GUI 511, but disappear when the selection arrow 515 is outside of the GUI 511. The user can use selection arrow 515 to select one of the controls in the control bars.

FIG. 5C is a display 520 including a graphical user interface 521 for a plurality of media feeds where a media feed 523 is selected and including metadata information shown in a side control/information bar 525, according to one embodiment. In this embodiment, which relates, for example, to GUI view 309 in FIG. 3, the selected representative image 523, which is selected using the selection arrow 527, is enlarged and a side bar 525 is provided next to the enlarged image 523. The side bar 525 includes various metadata information including, for example, the title or description of the media feed, location information where the content was taken at, the date on which the content was taken, various metadata tags, various comments from users, and a selection that allows users to add comments. If the add comment selection is chosen using the selection arrow 527, then, for example, a display such as the comments GUI view 329 shown in FIG. 3 can be displayed for the user to add comments.

FIG. 5D is a display 530 including a graphical user interface 531 for a plurality of media feeds where a media feed 533 is selected and including metadata information shown in overlays 535, according to one embodiment. In this embodiment, which relates, for example, to GUI view 309 in FIG. 3, the selected representative image 533, which is selected using the selection arrow 537, is enlarged and control/information bars 535 are overlaid onto the enlarged image 533.

FIG. 5E is a display 540 including a graphical user interface 541 for a plurality of media feeds where a media feed 543 is zoomed and including a control bar outline 545, according to one embodiment. In this embodiment, which relates, for example, to zoomed media feed GUI view 315 in FIG. 3, the selected representative image 543, which is selected using the selection arrow, is zoomed in and a control outline 545 is provided with a control bar 547 having various selection controls. In this embodiment, the control bar 547 includes selections to allow the user to download the media, to send the media via email, and to send the media to a mobile (see, e.g., reference numerals 323, 317, and 321, respectively, in FIG. 3). It is noted that in this embodiment, the selected representative image 543 is enlarged such that it extends outside of the normal window for the GUI, thus extending the size of the GUI.

FIG. 5F is a display 550 including a graphical user interface 551 for a plurality of media feeds where a video media feed 553 is selected and including metadata information shown in a side bar 555 and including a video control bar overlay 557, according to one embodiment. In this embodiment, which relates, for example, to GUI view 309 in FIG. 3, the selected representative image 553, which is selected using the selection arrow 559, is enlarged and a side bar 555 is provided next to the enlarged image 553. Additionally, a video playback control bar 557 is overlaid at the bottom of the enlarged image 553, to provide playback control (e.g., play, pause, stop, fast-forward, rewind) and playback information (e.g., a bar indicator of the playback progress, and/or playback time and progress). Thus, the user can use the selection arrow 559 to control the playback of the video content.

The selected enlarged images shown in FIGS. 5C-5F are maintained at a stationary position within the GUI; however, any selected video media feeds can continue to display the streaming video content. The non-selected images in the background can either continue to move GUI, or can be paused during the period of time in which a selected image is enlarged. Similarly, any non-selected video feeds in the background can either continue to stream video, or can be paused during the period of time in which a selected image is enlarged.

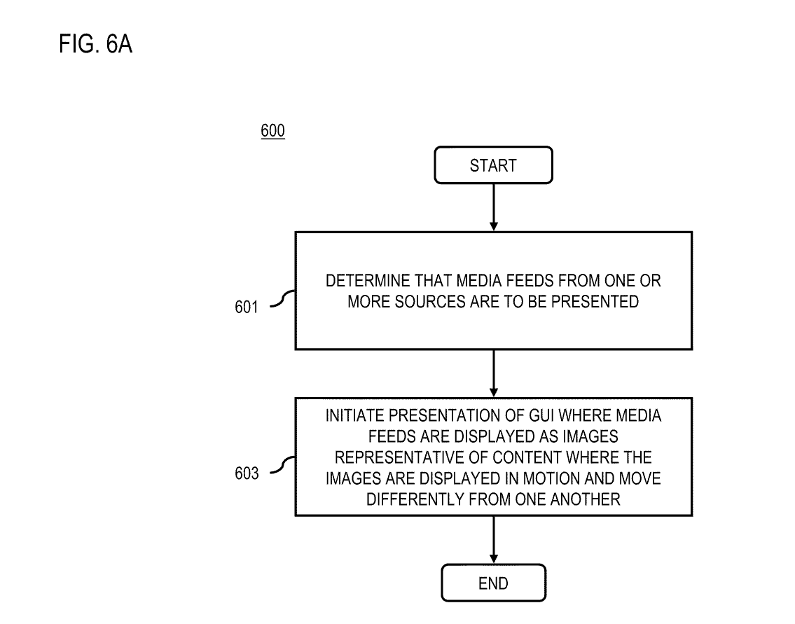

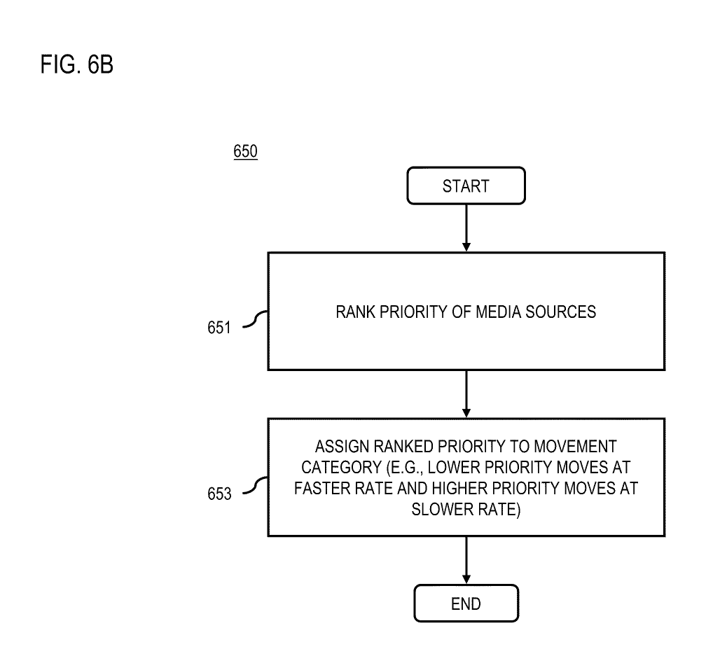

FIG. 6A is a method 600 of providing a graphical user interface for media feeds including representative images of the media feeds displayed in motion, according to one embodiment. In this embodiment, media feeds are received from one or more sources. In step 601, the process determines that the media feeds are to be presented. For example, as noted above with respect to FIG. 2, reader module 201 can be used to receive and support a wide variety of media file types, include various picture formats, video formats, audio formats, multimedia formats, etc. Such reader module 201 can receive media feeds from various media sources, parse the content of the media feed, as well as the metadata information (metadata 1, metadata 2, . . . , metadata N, such as keywords, title, description, location data, various tags, dates, comments, etc., that are captured automatically or entered by users) provided with the media feed and store the contents and metadata in a cache.

In step 603, the method includes initiating presentation of a graphical user interface where media feeds are displayed as images representative of the content, and where the images are displayed in motion and move differently from one another. For example, as can be seen in FIGS. 4A-4D, graphical user interfaces can be provided that display the media feeds in a dynamic and engaging manner. The representative images of the media feeds can move in various directions, the images can move in any variety of patterns, at any speed, at any depth of field within the GUI, and in various shapes and sizes that are either static or changing.

FIG. 6B is a method 650 of prioritizing media sources of media feeds and assigning movement rates to the priorities for use in a graphical user interface for the media feeds, according to one embodiment. In step 651, the various media sources or media feeds are ranked in terms of priority based on a priority algorithm. Thus, certain media sources can be given priority over others, and/or various media feeds can be given priority over other (e.g., based on subject matter, or date on which the media content was taken, or location at which the media content was taken, or number of comments on the media feed, or other metadata of the media feed).

In step 653, the ranked priorities are assigned to a certain movement category. For example, media sources and/or media feeds having a high priority ranking can be moved at a slow rate of speed in the GUI, while media sources and/or media feeds having a low priority ranking can be moved at a fast rate of speed in the GUI, thus making it easier for a user to view higher ranked media feeds as compared to lower ranked media feeds. Other examples can include a scenario in which media sources and/or media feeds having a high priority ranking can be shown in the foreground and/or in larger sizes in the GUI, while media sources and/or media feeds having a low priority ranking can be shown in the background and/or in smaller sizes in the GUI. The various priorities, rankings, and/or movement settings can be adjusted by the user and/or by the source of the media and/or by the service provider. Thus, the users are provided with a dynamic GUI that is very engaging to the users.

The described processes, in certain embodiments, advantageously provide reduced processing and enables power savings by employing a GUI for efficient presentation of content.

The processes described herein for providing a dynamic, visually streaming media feed display may be implemented via software, hardware, e.g., general processor, Digital Signal Processing (DSP) chip, an Application Specific Integrated Circuit (ASIC), Field Programmable Gate Arrays (FPGAs), etc., firmware or a combination thereof. Such exemplary hardware for performing the described functions is detailed below.

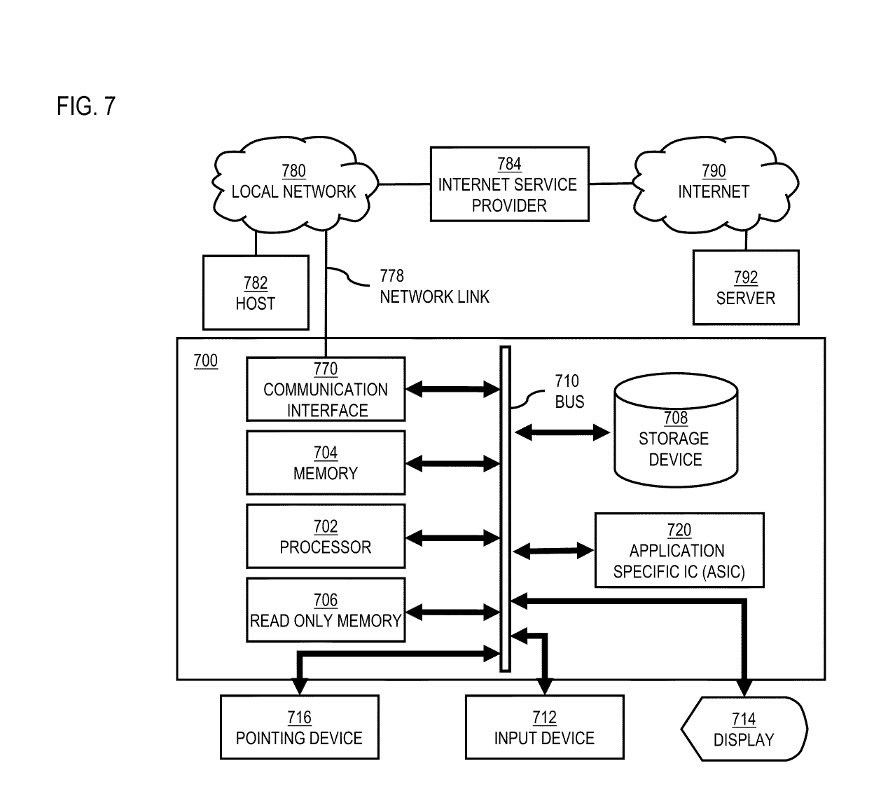

FIG. 7 illustrates a computer system 700 upon which an embodiment of the invention may be implemented. Computer system 700 is programmed to provide applications as described herein and includes a communication mechanism such as a bus 710 for passing information between other internal and external components of the computer system 700. Information (also called data) is represented as a physical expression of a measurable phenomenon, for example electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information related to associating applications as well as reporting and retrieval of state information. The set of operations include bringing information in from the bus 710 and placing information on the bus 710. The set of operations also include, for example, comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for associating applications. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for manipulating applications, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for querying and retrieving state information of applications.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

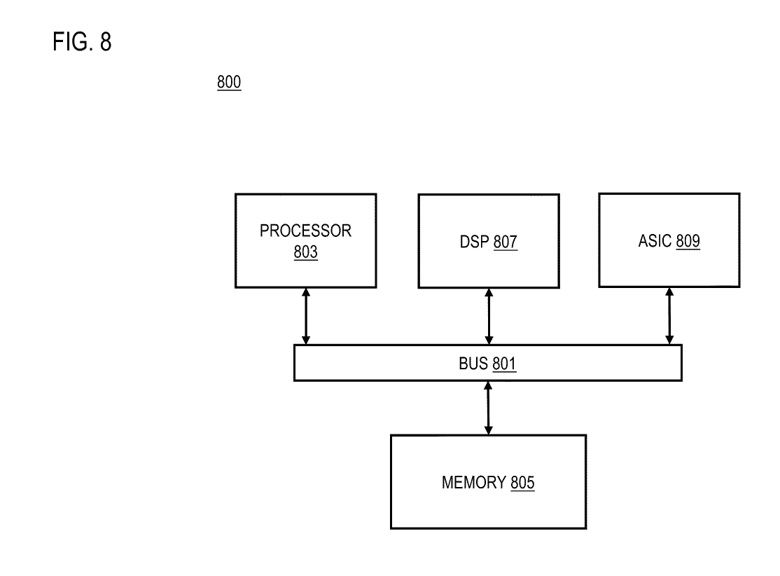

FIG. 8 illustrates a chip set 800 upon which an embodiment of the invention may be implemented. Chip set 800 is programmed to associate applications as described herein and includes, for instance, the processor and memory components described with respect to FIG. 8 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide association of widgets and utilization of state information. The memory 805 also stores the data associated with or generated by the execution of the inventive steps.

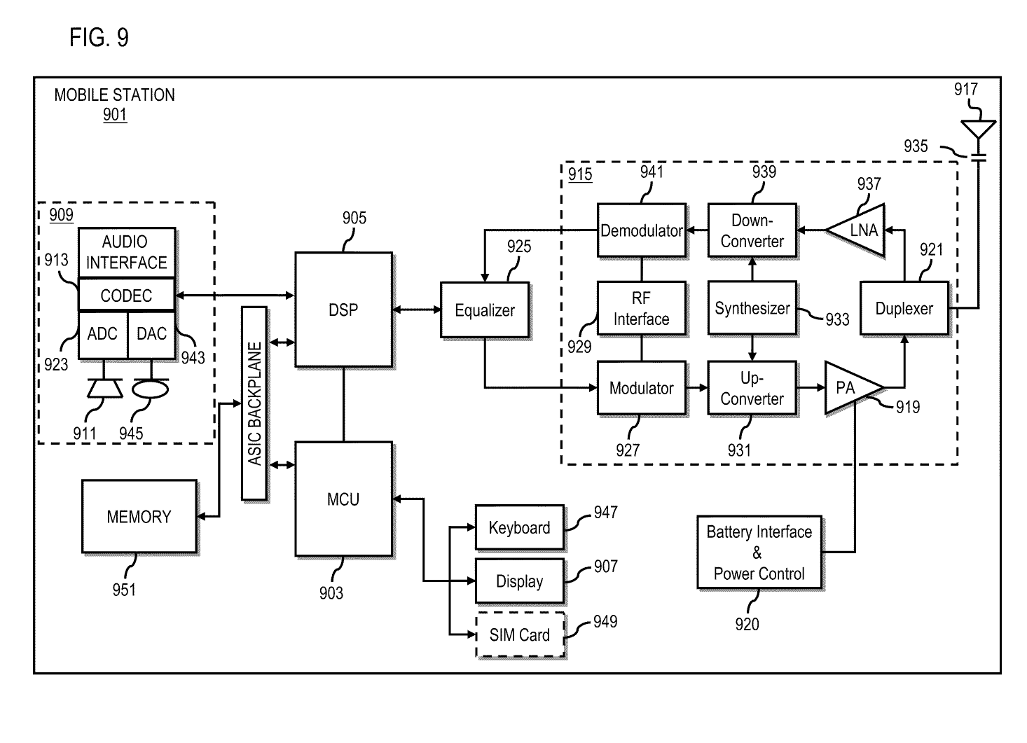

FIG. 9 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions, such as widgets. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 according to, for example, an multi-touch user interface. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining that a plurality of media feeds from one or more media sources are to be presented; and
initiating presentation of a graphical user interface in which the plurality of media feeds are displayed as a respective plurality of images representative of content of the respective media feed,
wherein the plurality of images are displayed in motion, and move differently from one another.

2. A method of claim 1, wherein the graphical user interface displays the plurality of images moving in different patterns, at different speeds, at different depths, and/or in different sizes from one another.

3. A method of claim 1, further comprising:
controlling movements of the plurality of images on the graphical user interface based on a priority scheme.

4. A method of claim 1, wherein the content of a first media feed of the plurality of media feeds is video content, and wherein the image of the first media feed displayed by the graphical user interface includes either a static image representing the video content or a streaming video of the video content.

5. A method of claim 1, wherein the plurality of media feeds include metadata, and wherein the graphical user interface displays the plurality of images in one or more groups based on the metadata.

6. A method of claim 5, wherein the graphical user interface displays content of the metadata with the plurality of images in the one or more groups.

7. A method of claim 1, wherein the graphical user interface displays the plurality of images in one or more groups based on the one or more media sources from which the plurality of images are received.

8. An apparatus comprising:
at least one processor; and
at least one memory including computer program code,
the at least one memory and the computer program code configured to, with the at least one processor, cause the apparatus to perform at least the following,
determine that a plurality of media feeds from one or more media sources are to presented, and
initiate presentation of a graphical user interface in which the plurality of media feeds are displayed as a respective plurality of images representative of content of the respective media feed,
wherein the plurality of images are displayed in motion, and move differently from one another.

9. An apparatus of claim 8, wherein the graphical user interface is caused to display the plurality of images moving in different patterns, at different speeds, at different depths, and/or in different sizes from one another.

10. An apparatus of claim 8, wherein the apparatus is further caused to control movements of the plurality of images on the graphical user interface based on a priority scheme.

11. An apparatus of claim 8, wherein the content of a first media feed of the plurality of media feeds is video content, and wherein the graphical user display is caused to display the image of the first media feed as either a static image representing the video content or a streaming video of the video content.

12. An apparatus of claim 8, wherein the plurality of media feeds include metadata, and wherein the graphical user interface is caused to display the plurality of images in one or more groups based on the metadata.

13. An apparatus of claim 12, wherein the graphical user interface is caused to display content of the metadata with the plurality of images in the one or more groups.

14. An apparatus of claim 8, wherein the graphical user interface is caused to display the plurality of images in one or more groups based on the one or more media sources from which the plurality of images are received.

15. A computer-readable storage medium carrying one or more sequences of one or more instructions which, when executed by one or more processors, cause an apparatus to perform at least the following:
present a graphical user interface that includes,
a plurality of images corresponding respectively to a plurality of media feeds from one or more media sources,
wherein the plurality of images are presented in motion, and move differently from one another.

16. A computer-readable storage medium of claim 15, wherein the graphical user interface displays the plurality of images moving in different patterns, at different speeds, at different depths, and/or in different sizes from one another.

17. A computer-readable storage medium of claim 15, wherein the content of a first media feed of the plurality of media feeds is video content, and wherein the image of the first media feed displayed by the graphical user interface includes either a static image representing the video content or a streaming video of the video content.

18. A computer-readable storage medium of claim 15, wherein the plurality of media feeds include metadata, and wherein the graphical user interface displays the plurality of images in one or more groups based on the metadata.

19. A computer-readable storage medium of claim 18, wherein the graphical user interface presents content of the metadata with the plurality of images in the one or more groups.

20. A computer-readable storage medium of claim 15, wherein the graphical user interface presents the plurality of images in one or more groups based on media sources from which the plurality of images are provided.
